(19) United States
(12) Patent Application Publication
(10) Pub. No.: US 2006/0005246 A1
(43) Pub. Date: Jan. 5, 2006

(54) System for providing security vulnerability identification, certification, and accreditation

(76) Inventor: Thomas R. Dalton, Mays Landing, NJ (US)

Correspondence Address: James H. Laughlin, Jr., Suite 100, 2099 Pennsylvania Avenue, N.W., Washington, DC, 20006, US

(21) Appl. No.: 11/053,332

(22) Filed: Feb. 9, 2005

Related U.S. Application Data
(60) Provisional application No. 60/542,468, filed on Feb. 9, 2004.

(51) Int. Cl. G06F 11/00

(52) U.S. Cl. 726/25; 726/1

(57) ABSTRACT

A system for providing security vulnerability identification, certification and accreditation is given whereby a computer program product having a computer useable medium and having a computer program logic stored thereon for enabling a processor on a computer system to provide security vulnerability identification, certification and accreditation of a system is provided where said computer program logic can employ a first computer readable code means including a database of security procedures and control objectives; a second computer readable code means for evaluating the system for each of the security procedures and control objectives; and a third computer readable code means for providing evaluation results.

The present invention is directed to a unique system for providing security vulnerability identification/security certification and accreditation that speeds the security evaluation process and provides managers at all levels with a command/agency actionable and ongoing security metric data. The automated tool was developed as a by product of multiple security vulnerability assessments/certification and accreditation efforts. With the greater emphasis on security brought on by the Federal Information Security Management Act (FISMA), there is an increased need to conduct and report security evaluations in a cost effective manner with actionable metric data. The system of the present invention fills this void in the security process.

There is no lack of security standards to “guide” the security evaluation/certification and accreditation process. Table 1 below documents the major standards that are applicable to government agencies.

TABLE 1

| | | No. of Control | No. of | |
|---|---|---|---|---|
| Standard | No. of Pages | Categories | Controls | Comments |
| ISO | 84 | 10 | ˜250 | No. of controls is difficult to |
| 17799 | | | | determine as individual controls |
| | | | | are not identified |
| DoD | 157 | 13 | 125 | The DITSCAP directive has 48 |
| DITSCAP | | | | pages, the directive and the |
| | | | | DITSCAP manual differ on |
| | | | | format of SSAA |
| NIST SP | 95 | 17 | 235 | The 17 control categories are |
| 800-26 | | | | grouped under Management,, |
| | | | | Operational, and Technical |
| | | | | headings |
| NIST SP | 229 | 18 | 126 | The 126 controls are for FIPS |
| 800-53 | | | | 199 defined “Low” system risk |
| | | | | level and has been issued in a |
| | | | | second public draft form |

Table 1 details the plethora of security categories and controls from the highest levels of government. Implementing directives of the department/agency are not included and would further expand the numbers and complexity of the guidance. For example, the directives in the table do not address specific equipment such as wireless devices—e.g. wireless email devices and cellular telephones. Each department/agency must provide specific guidance for these types of systems and that guidance would expand the base of control objectives/checklist items beyond the numbers in table 1.

Besides the sheer volume of controls/checklist items, the process (in particular the certification and accreditation (C&A) process) has major flaws. It is labor intensive and intrusive, voluminous, not actionable, not easily repeatable, does not ceatie user ownership, and expensive. The existing C&A process is labor intensive requiring significant resources external and internal to the organization to complete. The process requires user involvement primarily by intruding into their day-to-day operations but does not positively involve the users for the intrusion by providing feedback to them.

The C&A process creates tremendous amounts of paper. A routine DITSCAP C&A can produce over 300 pages of documentation. NMST's development of SP 800-37 will help streamline the paperwork burden, and FISMA will also help this with its focus on developing plans of objectives, action, and milestones (POA&Ms) for remedial actions. However, even if these initiatives reduce the paper volume, there will still be an issue in “separating the wheat from the chaff”. Current DITSCAP processes do not provide actionable results nor do they provide metric data to monitor security improvements over time. Even if the process produced actionable and metric data, the cost of the C&A effort virtually eliminates the ability to repeat the process on a regular basis limiting a manager's ability to reassess the progress of any remedial actions.

A vulnerability assessment/C&A effort is expensive. C&A efforts routinely run from $60,000 to $100,000. Federal Computer Week states that: “For high-risk systems the [C&A] process costs from $150,000 to $400,000 per system, respondents said. Low-risk systems can cost as much as $50,000 each, and medium-risk systems as much as $100,000. Agencies can have hundreds of systems requiring certification and accreditation.” The last sentence compounds the problem that departments/agencies face.

A preferred system would include the following attributes: reduces labor, provides minmal paperwork and operational intrusion, results in actionable information, is repeatable on a frequent basis, generates ongoing user involvement and ownership, and is inexpensive. The system of the present invention satisfies these requirements.

The system of the present invention is rooted in the standards shown in table 1. While the foundation of the tool is a database that is built directly from the standards, the tool is not limited to the standards alone. If the department/agency desires additional control objectives/checklist items, they can be added to the database. These department/agency specific items can be grouped by department/agency defined category/ies and can come from department/agency specific directives or procedures, or can simply be a security item that a manager desires to track across all systems. Once the foundational of the system of the present invention is defined, the tool can be refined and linked to each of the control objectives/checklist items.

The system of the present invention realizes that in the operational world, each control objective/checklist item will usually not be either: 1) fully implemented or 2) fully absent. There will not be an either/or (binary) state of implementation but a “shades of gray” state. Each control objective/checklist item (taken from the standards) will have varying degrees of implementation from being totally absent to being fully implemented. This begs the case for a scaled evaluation mechanism for each control objective/checklist item. NIST's SP 800-26 approximates this flexible scale but does not use a numeric scale and provides no guidance for the evaluator to determine which of the publication's five levels are appropriate for a given objective/item.

To implement this numeric scale concept consistently, a guide is provided to the evaluator for each of the control objective/checklist items. This scale goes from zero to ten with evaluator guidance provided for the even number ratings of 0, 2, 4, 6, 8, and 10. Odd numbered rating values are acceptable if the state of implementation of the control/item logically lies between any two even numbered values. To enter a value, all the guideline entries for lower valued entries on the scale must have been met. If desired, the guidelines can be expanded to cover both even and odd numbered values. While the scale for each control objective/checklist item is specific for each item, a sample for a single item could be:
0—This item is not addressed
2—There are informal procedures for implementing the control objective
4—There are documented procedures for the control objective
6—There are formal signed procedures for the control objective
8—There are reviewed documentation/artifacts demonstrating that the control objective is implemented and results are being reviewed.
10—All aspects of the control objective as defined by standard have been implemented and are institutionalized (a.k.a. Nirvana)

Once an evaluation scale has been defined for each control objective/checklist item, the next step is to take each objective/item and “link” each of the objectives to elements in three categories:
By organizational element (who within the organization is responsible for the objective/item)
By architectural element (where in the architecture does the implementation of this objective/item reside)
By the type of objective/item (what type of objective/item it is: management, operational, or technical)
   These linkages allow the objectives/items to be sorted by any of the three categories once the evaluation is completed. Additional linkages can be established if there is another grouping that the department/agency desires.

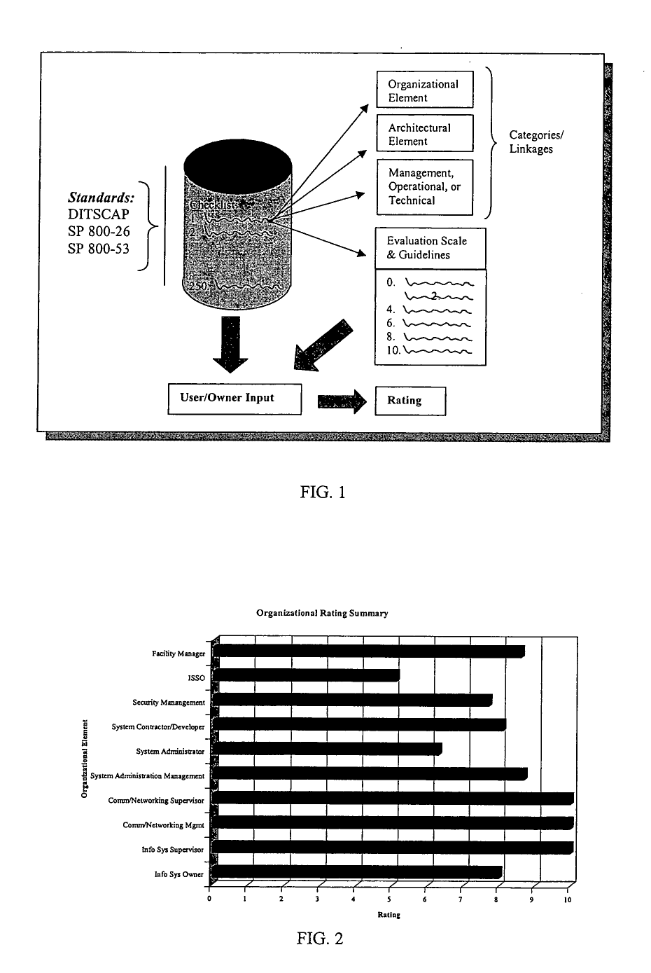

Once the numeric scale and associated guidelines has been built and the linkages for each item have been developed, the results are reviewed with the department/agency (particularly if the department/agency has added additional objectives/items to the standard baseline) to ensure that the scale/guidelines matches the desires of the department/agency and that the linkages match the organizational and architectural structure of the department/agency and the system architecture. The result is shown graphically in FIG. 1.

The evaluator only views the checklist and evaluation guidelines and inputs the rating for each checklist item. S/he does not see the organizational, architectural, and type linkages. The evaluator can only input the rating—all other data is read-only. Access is password and database protected.

Once the database and the associated linkages are solidified, the tool is ready to be used.

The major elements of the evaluation process have been described above—evaluation scale, guidance to the evaluator, linkages to organizational and architectural elements, etc.. These elements are necessary to establish the database in a form that can ultimately provide consistent, repeatable, and metrics-enabled results. Surrounding these technical aspects is an operational process that supports meeting those goals—the evaluation Process.

Once the database is developed, reviewed, and solidified, it is ready for use. There are different operational evaluation options available. The most familiar option is to have interviews with the various department/agency personnel that are involved in security for a given system and, based on those interviews and documentation review, enter the ratings into the database. This is a traditional method of conducting vulnerability assessments/C&A, and it ensures the greatest and most in-depth coverage of the system. It is also the most expensive in terms of time and dollars.

Another option is to either replicate or web-enable the database and provide it to the department/agency personnel to conduct an initial evaluation. The rating process is straightforward and with the evaluation guidelines, conducting the evaluation is not a laborious process. To further support the evaluation, because the control objectives/checklist items are already linked to the organizational structure, the total database of objectives/items can be further subdivided into “sub-checklists” that group checklist items for each member of the organization. In the SP 800-53 database, for example, the largest sub-checklist, broken down by organizational structure, has only approximately 20 objectives/items to be evaluated.

To ensure integrity of the evaluation in the second option, the organization can:
Require that documentation that supports meeting an objective/item be forwarded as part of the evaluation.
Treat the evaluation as an “initial” evaluation, as stated above. The returned evaluation database needs to be reviewed by the C&A security engineers and the engineers, where appropriate, schedule short focused interviews or request additional documentation to resolve any inconsistencies in the evaluation.

Regardless of whether the ratings are produced by security engineers or by organizational personnel, the organization can optionally set “standards” based upon the ratings. For example, the organization could require that any rating below a particular value requires a comment explaining why the low rating exists. Also if a rating is below a certain lower threshold rating, the organization can require that a specific plan be detailed for remediating the low rating (the database includes fields to capture both Comments and Actions).

The second option means an additional load on the organization to conduct their own evaluation. While this can save time and costs over time, it can be demanding to track the results (particularly if the evaluation database is subdivided). The tradeoff is that the organization gets user involvement by their own personnel completing the evaluation, and it focuses the expensive security engineering staff on handling exceptions based on the user evaluation results.

Once the evaluation is completed and the database is finalized, there is wealth of data available to further the objectives of the security program. The results can be “sliced and diced” in multiple ways. Because the individual objectives/items were linked up front to various categories and a guided numeric scale was used for the evaluation, data now can be rolled up by those categories to provide quantifiable metrics that can guide follow-on actions for the organization's security program. Specifically:
Individual elements of the organizational architecture will have a specific numeric value related to it, both as an average per objective/item and as a total system metric
Individual elements of the system architecture will have a specific numeric value related to it, both as an average per objective/item and as a total system metric
If thresholds were used to require input of Comments and Actions data, the baseline information required to develop the FISMA reporting requirements and the required POA&M will be available from the operational user.
If the evaluation is conducted by the organization (and not by security engineers), the organization's personnel will have total visibility into their metric rating
If the evaluation is conducted by the organization (and not by security engineers), the organization's personnel will have total visibility of what needs to be improved to change their rating
Over time, the rating system may provide to the organization not only a relative metric for each element of the organization but eventually an absolute metric among elements of the organization
In organizations with multiple systems being assessed or C&A'd, results across multiple systems can also be compared/contrasted.

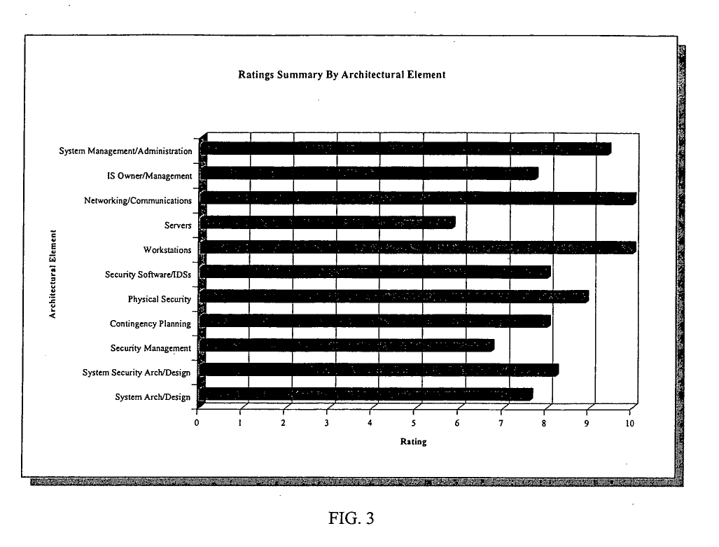

FIGS. 2 and 3 are exemplary basic charts developed from an actual C&A effort—the data was not created to make the charts “tell a story” but is pulled directly from a real C&A package submitted and approved by the Government.

FIG. 2 shows the organizational view of the data. The results show that the networking and the information supervisor area of the organization were working very smoothly. However the system security personnel (ISSO) and System Administration organizational did not fare as well. The major underlying cause of the poor ratings for the security personnel and system administration areas was that the contractual relationship with the prime contractor would not allow the security and system administration personnel to apply security patches to system software in a timely manner. Therefore deadlines for applying patches were missed and the underlying system was exposed to known vulnerabilities.

The chart of FIG. 2 is important because it underlines the fact that the present tool cannot take the human element out of the process. It can identify security risk areas but only proper analysis of the data will lead to an understanding of the root cause/s of a poor rating. The tool is a security risk identification tool—it is not a security assessment panacea. It can direct the security engineer where to focus his/her energies but cannot perform an analysis for that engineer.

FIG. 3 shows a chart of the same system but now addressing the architectural breakout of the data. If the organizational data illuminated issues in the security and system administration organizational elements, it would logically follow that there should be issues with servers and security management. In this case the chart of FIG. 3 verifies that relationship. If the data did not support this thesis, then this also would provide additional information to the reviewer to examine.

An additional result from the same C&A effort is shown in Table 2 below. Of note is that each organizational element has a specific rating total. Over time, the data from this evaluation can be compared with results from later evaluations.

TABLE 2

| | | Rating | |
|---|---|---|---|
| Organizational Category | | Total | Avg. |
| Info Sys Owner | Summary for 50 detail records | 400 | 8 |
| Info Sys Supervisor | Summary for 1 detail record | 10 | 10 |
| Comm/Networking | Summary for 5 detail records | 50 | 10 |
| Mgmt | | | |
| Comm/Networking | Summary for 3 detail records | 30 | 10 |
| Supervisor | | | |
| System Administration | Summary for 23 detail records | 200 | 8.7 |
| Management | | | |
| System Administrator | Summary for 8 detail records | 50 | 6.3 |
| System | Summary for 54 detail records | 438 | 8.1 |
| Contractor/Developer | | | |
| Security Management | Summary for 44 detail records | 340 | 7.7 |
| ISSO | Summary for 39 detail records | 200 | 5.1 |
| Facility Manager | Summary for 21 detail records | 180 | 8.6 |
| Totals: | | 1898 | |

The total system rating that the system of the present invention creates should not be overlooked. This can be used to compare ratings among various systems (the rating is only of value when used among systems using the same rating database). Over time that data can become a barometer of the system security status—both for the system as whole and for individual elements of the organization and architecture.

The standards database (plus department/agency add-ons), the rating guidance, the linkages, the ratings themselves, etc. are all left with the reviewed organization. This allows the organization to “slice and dice” the data in any manner that they choose and also allows the organization to repeat all or portions of the evaluation on a schedule that they choose to ensure that security posture is continually improved.

The system of the present invention is a flexible standards based-tool that includes an evaluation process that maximizes its value and capability. The result is a combination that structures and provides quantifiable metric security data, provides flexible reporting from the database, uses a process the increases user involvement and visibility, decreases vulnerability and C&A effort, and decreases overall cost to the department/agency. This combination provides a flexible and relatively inexpensive methodology to meet the ongoing internal security program needs and the external reporting requirements to higher echelons.

What is claimed is:

1. A computer program product comprising a computer useable medium having a computer program logic stored thereon for enabling a processor on a computer system to provide security vulnerability identification, certification and accreditation of a system, said computer program logic comprising:
a first computer readable code means including a database of security procedures and control objectives;
a second computer readable code means for evaluating the system for each of the security procedures and control objectives;
a third computer readable code means for providing evaluation results.

2. A method of providing security vulnerability identification, certification and accreditation of a system, comprising:
providing a database of security procedures;
providing one or more control objectives;
evaluating the system for each of the security procedures and control objectives; and
providing evaluation results.
